(19) United States
(12) Patent Application Publication
(10) Pub. No.: US 2004/0165483 A1
(43) Pub. Date: Aug. 26, 2004

(54) System and method for bookmarking DVDs

(75) Inventor: Robert Allan Unger, El Cajon, CA (US)

Correspondence Address: Rogitz & Associates, Suite 3120, 750 B Street, San Diego, CA, 92101, US

(73) Assignees: SONY CORPORATION, Tokyo (JP); SONY ELECTRONICS INC., Park Ridge, NJ

(21) Appl. No.: 10/374,888

(22) Filed: Feb. 26, 2003

(51) Int. Cl. G11B 7/085

(52) U.S. Cl. 369/30.09; 369/30.24

(57) ABSTRACT

A bookmark button on a remote control device can be depressed to store a bookmark in a DVD player's memory without interrupting play. The bookmark includes a play counter value and a timestamp. When a viewer subsequently wishes to start play from the bookmark, the DVD player is stopped or paused, the bookmark button manipulated, and a menu listing bookmarks pertaining to the disk being played is displayed. The user may navigate through the list and select a bookmark, and the DVD player automatically resumes play at the selected bookmarked point.

### FIELD OF THE INVENTION

The present invention relates generally to multimedia such as DVDs.

### BACKGROUND OF THE INVENTION

Digital Video Disks (DVDs) are MPEG II-encoded data storage devices that are useful for storing movies, music, and other multimedia content for playback. To playback a movie, for example, the DVD is inserted into a DVD player and the movie is displayed on an output device such as a TV that is coupled to the DVD player.

As a movie progresses, a viewer might want to “bookmark” a particular spot in the movie. While movies on DVDs are broken into chapters that can be searched through and selected for presentation from the start of any given chapter, the only way to note a spot within a chapter to later return exactly to that spot is to pause the DVD and note the value on the elapsed play time counter provided on most DVD players. Unfortunately, this disrupts the flow of the movie, as the play counter is noted and typically written down. Then, to return to the noted spot, an obscure key sequence typically must be input. Recognizing these drawbacks, the solution provided herein has been provided to answer one or more of them.

### SUMMARY OF THE INVENTION

A multimedia play system includes a content storage disk player that is configured for playing multimedia stored on a content storage disk such as a DVD. A remote control device controls the player. In accordance with the present invention, the remote control device is manipulable to cause the player to store in memory a bookmark location on the disk.

In a preferred embodiment, the bookmark location can include a play counter value. A timestamp value may be stored along with the bookmark location, with the timestamp value representing the time of a bookmark. Also, if desired disk identity information can be stored along with the bookmark location.

In a non-limiting embodiment manipulation of a bookmark element such as a button or key on the remote control device causes the player to store in memory the bookmark location. Furthermore, subsequent manipulation of the bookmark element when the player is paused or stopped causes the player to display a bookmark menu. A user can then select a bookmark from the menu to cause the player to resume playing a disk from the bookmark location.

In another aspect, a method for playing a content storage disk includes playing the disk in a disk player, and during play, manipulating a bookmark element on an input device to generate a bookmark signal. In response to the bookmark signal, a disk location is stored.

In yet another aspect, a system includes content storage means for storing multimedia content, and content playing means for playing the content. Control means causes the content playing means to automatically store a bookmark location of the content storage means.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is an architectural block diagram of the present system;

FIG. 2 is a flow chart of the logic for bookmarking a DVD; and

FIG. 3 is a flow chart of the playback logic.

### DETAILED DESCRIPTION OF THE PREFERRED EMBODIMENT

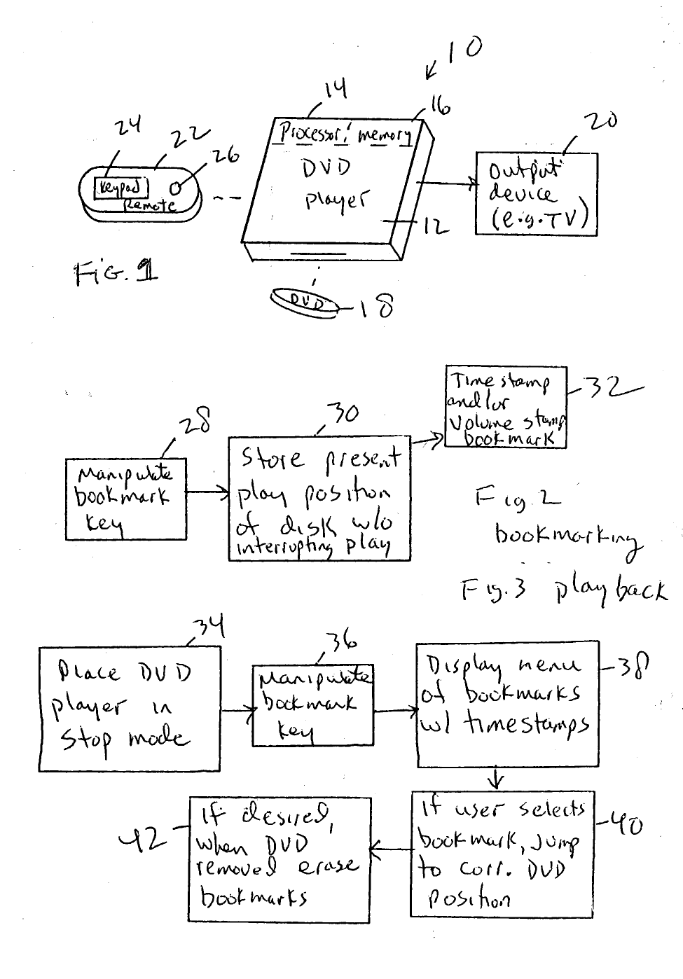

Referring initially to FIG. 1, a system is shown, generally designated 10, that includes a DVD player 12 having a processor 14 and a memory 16, preferably a solid state non-volatile memory such as flash memory but potentially other types of volatile or non-volatile memory including other types of solid state memory, disk memory, etc. The DVD player 12 can be used to play DVDs 18 (only a single DVD shown) for presentation of multimedia content on the DVD 18 such as movies on an output device 20 such as a television. While the disclosure focusses on DVDs, other multimedia storage devices/disks including MPEG 4-formatted disks are filly contemplated by the present invention.

A hand-held remote control device 22 can be provided to remotely control the DVD player 12 and, if desired, the output device 20 as well in accordance with remote control principles known in the art. The remote control device 22 can include a keypad 24, with one of the keys functioning as,the below-described bookmark key. Or, a separate special key 26 can be provided on the remote control device 22 to function as the below-described bookmark key. A bookmark key can also be provided on the chassis of the DVD player 12 if desired.

Now referring to FIG. 2, the logic for bookmarking a location in the content stream of the disk 18 can be seen. Commencing at block 28, when a viewer wishes to bookmark a particular spot in, e.g., a movie being played, the viewer manipulates the bookmark key on the remote control device 22. At block 30, the processor 14 receives the signal generated by the bookmark key and stores the present play position of the disk 18 as indicated by, e.g., the play counter of the DVD player 12. The position can be stored in the memory 16. It will readily be appreciated that the processor 30 executes the bookmarking processing without interrupting the play of the multimedia. At block 32, a timestamp indicating the time the bookmark signal was received, and/or the elapsed run time of the movie at the point of bookmarking, is stored along with the bookmark, as well as information indicating the identity of the disk 18 being played, if desired.

Proceeding to the playback logic of FIG. 3, commencing at block 34, when it is desired to jump to a bookmark, the DVD player 12 can be placed in a stop or pause mode, and then the bookmark key manipulated at block 36. This causes the DVD player 12 to display at block 38 a menu of bookmarks along with their timestamps and, if desired, the identity of the disk to which they pertain, highlighting those bookmarks that are included on the disk that is present. Bookmarks for multiple disks would pertain to a “jukebox” type player. Proceeding to block 40, the viewer may select a bookmark from the menu using conventional navigational buttons on the remote control device 22, and if he or she does so the logic causes the DVD player 12 to immediately jump to the corresponding disk position and begin playing the disk at that point. At block 42, if desired upon removal of the disk the bookmarks can be erased from memory. Or, the bookmarks can persist in non-volatile memory, such that when the disk is re-inserted its identity is used to identify and if desired display the bookmarks associated with that disk.

While the particular SYSTEM AND METHOD FOR BOOKMARKING DVDS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconciliable with the present specification and file history.

What is claimed is:

1. A system, comprising:
a content storage disk player configured for playing multimedia stored on at least one content storage disk; and
at least one remote control device controlling the player, the device being manipulable to cause the player to store in memory at least one bookmark location on the disk.

2. The system of claim 1, wherein the bookmark location includes at least one play counter value.

3. The system of claim 1, wherein at least one time value is stored along with the bookmark location, the time value representing the time of a bookmark.

4. The system of claim 1, wherein disk identity information is stored along with the bookmark location.

5. The system of claim 1, wherein manipulation of at least one bookmark element on the remote control device causes the player to store in memory at least the bookmark location.

6. The system of claim 5, wherein manipulation of the bookmark element at least when the player is in at least one predetermined mode other than a play mode causes the player to display a bookmark menu.

7. The system of claim 6, wherein a user can select a bookmark from the menu to cause the player to resume playing a disk from the bookmark location.

8. The system of claim 1, wherein the disk is a DVD.

9. A method for playing a content storage disk, comprising:
playing the disk in a disk player;
during play, manipulating a bookmark element on an input device to generate a bookmark signal; and
in response to the bookmark signal, storing at least a disk location while the disk is playing.

10. The method of claim 9, wherein the disk location includes a play counter value.

11. The method of claim 9, comprising storing at least one timestamp value along with the disk location, the timestamp value representing the time of a bookmark.

12. The method of claim 9, comprising storing disk identity information along with the disk location.

13. The method of claim 9, comprising manipulating the bookmark element at least when the player is in a predetermined mode other than a play mode to cause the player to display a bookmark menu.

14. The method of claim 13, comprising selecting a bookmark from the menu to cause the player to resume playing a disk from the disk location.

15. The method of claim 9, wherein the disk is a DVD.

16. A system, comprising:
content storage means for storing multimedia content;
content playing means for playing the content; and
control means for causing the content playing means to automatically store a bookmark location of the content storage means.

17. The system of claim 16, wherein the content storage means is a disk and the content playing means is a disk player, and the control means includes at least one bookmark element manipulable by a user to bookmark a location on the disk.

18. The system of claim 17, wherein the bookmark location is stored along with at least one of: time information, and disk identity information.

19. The system of claim 18, wherein the bookmark element is manipulable to cause a menu of bookmarks to be displayed.

20. The system of claim 19, wherein a bookmark can be selected from the menu of bookmarks to cause the player to immediately play the disk from the bookmark location.
